(19) United States
(12) Patent Application Publication
(10) Pub. No.: US 2016/0345188 A1
(43) Pub. Date: Nov. 24, 2016

(54) LOW-COST RANDOMNESS IN WLAN CHIPSETS FOR INTERNET OF EVERYTHING

(71) Applicant: QUALCOMM Incorporated, San Diego, CA (US)

(72) Inventors: Kenneth CHEN, San Diego, CA (US); Anand PALANIGOUNDER, San Diego, CA (US); Soo Bum LEE, San Diego, CA (US)

(21) Appl. No.: 15/062,932

(22) Filed: Mar. 7, 2016

Related U.S. Application Data
(60) Provisional application No. 62/165,045, filed on May 21, 2015.

(51) Int. Cl. H04W 24/02

(52) U.S. Cl. CPC H04W 24/02; H04W 84/12

(57) ABSTRACT

Aspects of the disclosure are related to a method for generating random numbers based on WLAN signal measurements, comprising: measuring WLAN signals; harvesting entropy based on the WLAN signal measurements; and generating a random number based on the harvested entropy.

### CROSS REFERENCE TO RELATED APPLICATIONS

The present Application for Patent claims priority to Provisional Application No. 62/165,045 entitled “LOW-COST RANDOMNESS IN WLAN CHIPSETS FOR INTERNET OF EVERYTHING” filed on May 21, 2015, which is incorporated herein by reference in its entirety.

### FIELD

The subject matter disclosed herein relates to electronic devices, and more particularly to methods, apparatuses, and systems for generating random numbers for use by electronic devices.

### BACKGROUNDS

The idea of the Internet of Everything, or Internet of Things (IoT) refers to equipping different products (i.e., “things”) with embedded electronics, software, sensors, and connectivity to enable these products to exchange data with the manufacturer, operator and/or other connected devices through the existing Internet infrastructure. Products with IoT capabilities can include a wide variety of devices. As non-limiting examples, such devices may include smart thermostats, washer/dryers with remote monitoring functions, heart monitoring implants, biochip transponders on farm animals, automobiles with built-in sensors, or field operation devices that assist fire-fighters in search and rescue, etc.

Random numbers are often used in generating appropriate security parameters in a computer system. It is, however, a challenging task to generate high quality random numbers, i.e., sequences of unpredictable and non-deterministic numbers that are close to being truly random, with a computer system. Moreover, the particular configuration and relative low cost of IoT devices pose challenges for random number generation.

### SUMMARY

One aspect of the disclosure is related to a method for generating random numbers based on WLAN signal measurements, comprising: measuring WLAN signals; harvesting entropy based on the WLAN signal measurements; and generating a random number based on the harvested entropy.

Another aspect of the disclosure is related to an apparatus for generating random numbers based on wireless local area network (WLAN) signal measurements, comprising: a memory; and a processor coupled to the memory, the processor to: measure WLAN signals; harvest entropy based on the WLAN signal measurements; and generate a random number based on the harvested entropy.

Yet another aspect of the disclosure is related to an apparatus for generating random numbers based on wireless local area network (WLAN) signal measurements, comprising: means for measuring WLAN signals; means for harvesting entropy based on the WLAN signal measurements; and means for generating a random number based on the harvested entropy.

Still another aspect of the disclosure is related to a non-transitory computer-readable medium including code which, when executed by a processor, causes the processor to perform a method comprising: measuring WLAN signals; harvesting entropy based on the WLAN signal measurements; and generating a random number based on the harvested entropy.

### BRIEF DESCRIPTION OF THE DRAWINGS

FIG. 1 illustrates an environment in which embodiments of the disclosure may be practiced.

FIG. 2 is diagram illustrating an example device with which embodiments of the disclosure may be practiced.

FIG. 3 is an example block diagram illustrating various components involved in the operation of embodiments of the disclosure.

FIG. 4 is a flowchart illustrating an example method for generating random numbers based on WLAN signal measurements.

### DETAILED DESCRIPTION

Embodiments of the disclosure are related to apparatuses, systems, and methods for generating random numbers based on wireless local area network (WLAN) signal measurements.

As discussed above, random numbers are often used in generating appropriate security parameters in a computer system. For example, generating random numbers based on entropy harvested from chaotic physical processes may improve the quality of random numbers. Some computer systems, for example, may rely on the seemingly random behavior of a human typing on a keyboard or moving a mouse pointer or seemingly random disk seek time to introduce entropy.

Because Iot devices often lack input devices and disks, entropy harvest based on seemingly random human inputs or disk seek time cannot be utilized. Moreover, dedicated hardware random number generators that harvest environmental entropy are generally too costly for Iot devices.

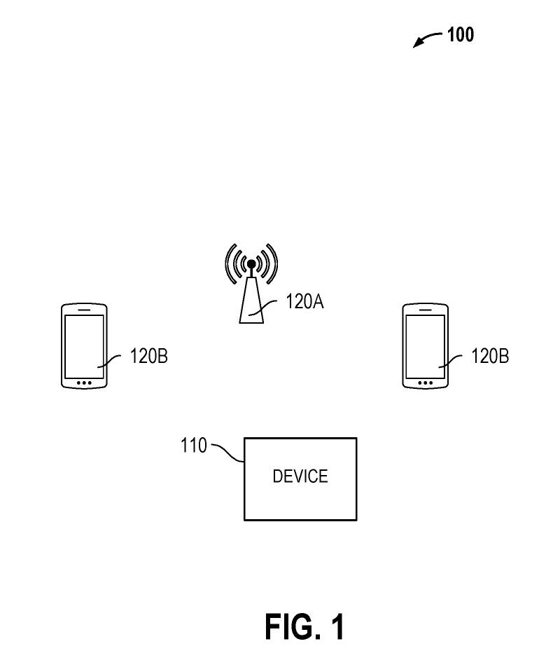

Referring to FIG. 1, an example environment 100 in which embodiments of the disclosure may be practiced is shown. Random numbers may be generated inside the device 110, which may be an Iot device. The device 110 may be equipped with a wireless communication interface that enables the device 110 to access WLANs. Within the environment 100, one or more other devices 120 with WLAN access capabilities may be present. The other devices 120 may include one or more access points 120A and/or one or more terminal user devices 120B. The terminal user devices 120B may include other Iot devices, for example.

Therefore, at least from time to time, radio frequency (RF) communications occur between the access points 120A, the terminal user devices 120B, and/or the device 110. For example, the RF communications may occur over 2.4 GHz and/or 5 GHz industrial, scientific, and medical (ISM) RF bands in accordance with one or more protocols within the IEEE 802.11 family of protocols.

In one embodiment, the device 110 may harvest entropy based on measurements made of the RF WLAN signals within the environment 100 and generate random numbers based on the harvested entropy.

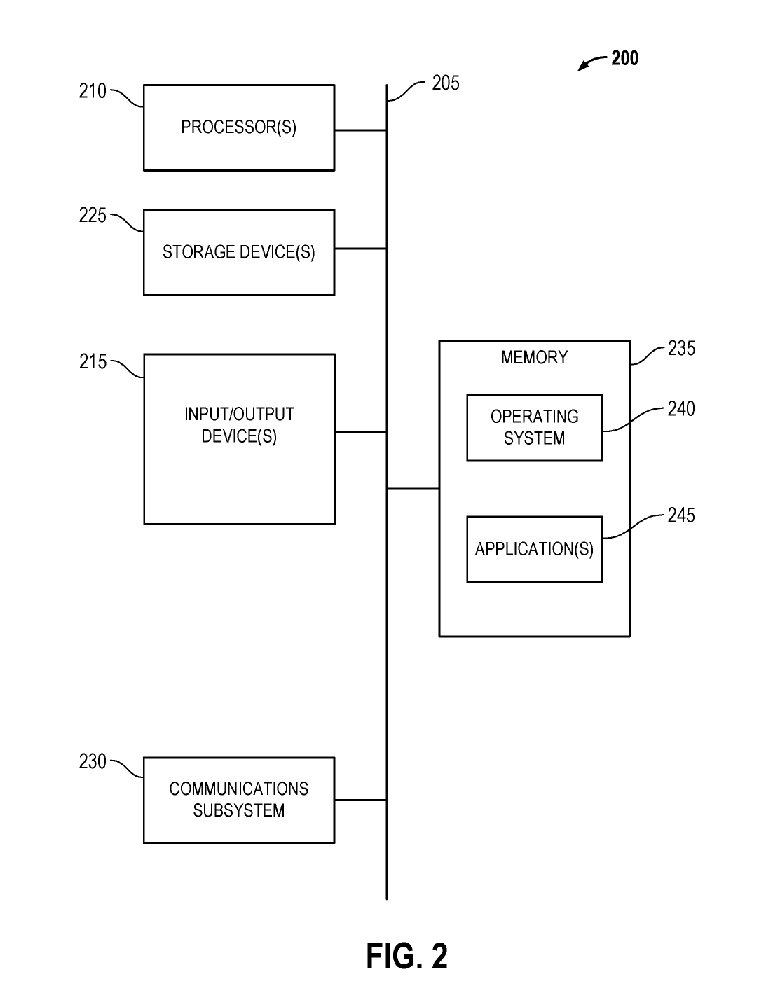

Referring now to FIG. 2, an example device 200 adapted for generating random numbers based on WLAN signal measurements is illustrated. The device 200 may be the Iot device 110 of FIG. 1. The device 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input/output devices 215 such as a mouse, a keyboard, a speaker, a printer, and/or the like. The processor 210 may be coupled to the memory 235, and may be configured to measure one or more WLAN signals, harvest entropy based on the measured WLAN signals, and generate random numbers based on the harvested entropy.

The device 200 may further include (and/or be in communication with) one or more non-transitory storage devices 225, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The device 200 might also include a communication subsystem 230, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 230 may permit data to be exchanged with a network, other computer systems/devices, and/or any other devices described herein. In many embodiments, the device 200 will further comprise a working memory 235, which can include a RAM or ROM device, as described above.

The device 200 also can comprise software elements, shown as being currently located within the working memory 235, including an operating system 240, device drivers, executable libraries, and/or other code, such as one or more application programs 245, which may comprise or may be designed to implement methods, and/or configure systems, provided by other embodiments, as described herein. Merely by way of example, one or more procedures described with respect to the method(s) discussed below might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 225 described above. In some cases, the storage medium might be incorporated within a computer device, such as the device 200. In other embodiments, the storage medium might be separate from a computer device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the device 200 and/or might take the form of source and/or installable code, which, upon compilation and/or installation on the device 200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

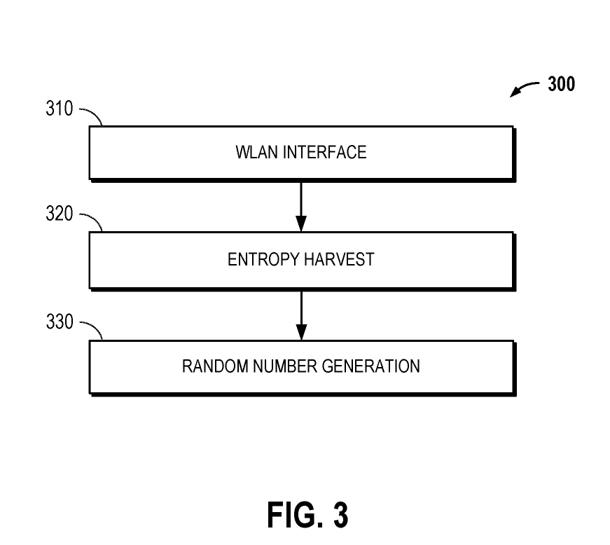

Referring to FIG. 3, an example block diagram 300 illustrating various components involved in the operation of embodiments of the disclosure. The various components illustrated in FIG. 3 may be hardware components or components composed of a combination of hardware and software, and may be deployed in the device 110 of FIG. 1 and the device 200 of FIG. 2.

WLAN signal measurements may be made with a WLAN interface component 310, which may be implemented with the processor 210 and the communications subsystem 230 of FIG. 2. Entropy may be harvested with the entropy harvest component 320, which may be implemented with the processor 210 of FIG. 2, based on WLAN signal measurements made with the WLAN interface component 310. Random numbers may be generated with the random number generation component 330, which may be implemented with the processor 210 of FIG. 2, based on the entropy harvested with the entropy harvest component 320.

The IEEE 802.11 standard for WLAN defines a distributed coordination function (DCF) for sharing access to the medium based on the carrier sense multiple access with collision avoidance (CSMA/CA) protocol. According to the standard, a node listens to the channel before transmission to determine whether someone else is transmitting. The receiving node sends an acknowledge packet (ACK) a short time interval after receiving the packet. If an ACK is not received, the packet is considered lost and a retransmission is arranged.

DCF consists of a basic access mode as well as an optional Request to Send/Clear to Send (RTS/CTS) access mode. In basic access mode, the node senses the channel to determine whether another node is transmitting before initiating a transmission. If the medium is sensed to be free for a predetermined DCF inter-frame space (DIFS) time interval, the transmission will proceed. If the medium is busy, the node defers its transmission until the end of the current transmission and then it will wait an additional DIFS interval and generate a random backoff delay uniformly chosen in the range [0, W-1], where W is called the backoff window. The busy/idle status of the medium may therefore be random.

The backoff timer is decreased as long as the medium is sensed to be idle for a DIFS, and frozen when a transmission is detected on the medium, and resumed when the channel is detected as idle again for a DIFS interval. When the backoff reaches 0, the node transmits its packet. The initial backoff window is set to W=1. If two or more nodes decrease their backoff timer to 0 at the same time, a collision occurs, at which time the backoff window is doubled for each retransmission until it reaches a maximum value.

A short inter-frame space (SIFS) time interval is used to give priority access to ACK packets. When a packet is received correctly, the destination node waits for a SIFS interval immediately after the reception has completed and transmits an ACK packet back to the source node confirming the correct reception. If the source node does not receive an ACK packet due to collision or transmission errors, it reactivates the backoff algorithms after the channel remains idle for an extended inter-frame space (EIFS) time interval. The collisions may be random.

Carrier sensing is done in two ways: physical carrier sensing by detecting activity on the radio interface, and virtual carrier sensing, which is performed by the RTS/CTS access mode. To implement virtual carrier sensing, each node sends duration information in the header of RTS and CTS packets. The duration information indicates the amount of time the medium is to be reserved for transmitting the data and returning ACK packets after the end of the current frame.

The stations in the same basic service set (BSS) uses the duration information to update its network allocation vector (NAV) that represents the amount of time it has to defer in accessing the medium. By using virtual carrier sensing, all nodes within the same BSS learn how long the channel will be used for this data transmission. The NAV may be random.

In the RTS/CTS access mode, prior to the data transmission, the sending node sends an RTS packet to announce the upcoming transmission. When the destination node receives the RTS it sends a CTS packet after a SIFS interval. The sending node is allowed to transmit its data packet only if it receives the CTS packet correctly. The time it takes to transmit a frame may be random.

Whenever a backoff occurs the backoff time is uniformly chosen in the range [0, W-1]. After each unsuccessful transmission the backoff window size is doubled, up to a predetermined maximum value. Once the backoff window size reaches its maximum value it stays at that value until it is reset. The value of W is reset after every successful transmission of a data or RTS packet, or when a retry counter reaches its limit.

According to the IEEE 802.11 standard, at the physical layer (PHY), both the clients and the access points may detect energy from non-WLAN RF sources (e.g., Bluetooth, cordless phones, microwave ovens, radars, etc.) and from access points and clients that belong to a different extended service set (ESS). The frames from these other access points and clients may need to be decoded in order to update the NAV accordingly.

Therefore, within a WLAN environment, the busy/idle status of the medium, the NAVs, collisions, the time it takes to transmit a frame, etc., all can serve as sources of entropy.

In one embodiment, the device 110 may transmit a wildcard probe request, and harvest entropy based on received probe responses.

In different embodiments, WLAN measurements that may be used as sources of entropy may include: signal strength measurements for beacon signals, frames between client devices and access points, frames between client devices, etc., measured in terms of either received signal strength indicator (RSSI) or received channel power indicator (RCPI), or any combination thereof. To use signal strength measurements as entropy sources, raw measurement values may be preferable over scaled measurement values, and high-precision measurements may be preferred. Moreover, WLAN signal strength measurements that may be used as entropy sources include: the variation of the RSSIs or the variation of RCPIs measured in a predefined measurement interval, signal to noise ratio (SNR), signal power alone, noise power alone, or any combination thereof.

In different embodiments, WLAN measurements that may be used as sources of entropy may also include: a time it takes to receive probe responses after transmitting a probe request, a time interval from a measurement start time instant (e.g., the time of a system event, such as system startup) to a time instant when a first probe response is received, a time interval from a measurement start time instant (e.g., the time of a system event, such as system startup) to a time instant when a first beacon frame is received for each channel, a time it takes to gain access to the medium, a time interval from a measurement start time instant (e.g., the time of a system event, such as system startup) to a time instant when an authentication response is received, a time interval from a measurement start time instant (e.g., the time of a system event, such as system startup) to a time instant when an association is successfully established, or a number of distinct addresses observed during a selected time interval, etc. The above lists are not exhaustive, and any two or more items from the lists may be suitably combined to serve as entropy sources. Persons skilled in the art will appreciate that the measurement start time instance may include any time chosen by the device (e.g., from system startup until when the WLAN chipset begins to send or receive wireless signals/messages).

The harvested entropy may be stored in an entropy pool. Random numbers may be generated based on the harvested entropy stored in the entropy pool as needed. Techniques may be applied to reduce or eliminate bias (e.g., unbalanced distribution of 1s and 0s in the generated random bit-stream) in the random numbers generated. For example, a software whitening technique or a hash function may be applied to the generated random numbers to reduce or eliminate the bias.

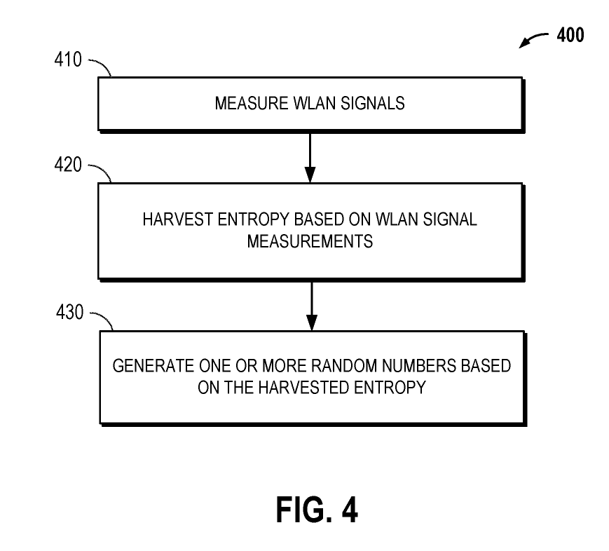

Referring to FIG. 4, a flowchart illustrating an example method 400 for generating random numbers based on WLAN signal measurements is shown. At block 410, a processor of device 110 (FIG. 1) may measure WLAN signals. At block 420, a processor of device 110 may harvest entropy based on the WLAN signal measurements. Various examples of WLAN signal measurements that may serve as entropy sources have been described in detail above. At block 430, a processor of device 110 may generate one or more random numbers based on the harvested entropy. Additionally, one or more de-biasing techniques may be applied to reduce or eliminate bias in the generated random numbers. The generated random numbers may be used, for example, for key derivation in a cryptographic operation.

Therefore, by utilizing embodiments of disclosure described herein, an IoT device with no or limited input devices and/or no disk may generate high quality random numbers for use in cryptographic operations based on various WLAN signal measurements without reliance on a costly hardware random number generator.

Various implementations of an application or system that generates random numbers based on WLAN signal measurements have been previously described in detail. It should be appreciated that application or system that generates random numbers based on WLAN signal measurements, as previously described, may be implemented as software, firmware, hardware, combinations thereof, etc. In one embodiment, the previous described functions may be implemented by one or more processors (e.g., processor 210) of a device 200 to achieve the previously desired functions (e.g., the method operations of FIG. 4). The high quality random numbers thus generated may be used in, for example, cryptographic operations.

Example methods, apparatuses, or articles of manufacture presented herein may be implemented, in whole or in part, for use in or with mobile communication devices. As used herein, “mobile device,” “mobile communication device,” “hand-held device,” “tablets,” etc., or the plural form of such terms may be used interchangeably and may refer to any kind of special purpose computing platform or device that may communicate through wireless transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, wearable devices, or the like. It should be appreciated, however, that these are merely illustrative examples relating to mobile devices that may be utilized to facilitate or support one or more processes or operations described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,” “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method for generating random numbers based on wireless local area network (WLAN) signal measurements, comprising:
measuring WLAN signals;
harvesting entropy based on the WLAN signal measurements; and
generating a random number based on the harvested entropy.

2. The method of claim 1, wherein the WLAN signal measurements include signal strength measurements for beacon signals, frames between client and access points, frames between client devices, or combinations thereof.

3. The method of claim 2, wherein the signal strength is measured in either received signal strength indicator (RSSI) or received channel power indicator (RCPI).

4. The method of claim 1, wherein the WLAN signal measurements include the variation of the received signal strength indicator (RSSI)s or the variation of the received channel power indicator (RCPI)s in a selected measurement interval.

5. The method of claim 1, wherein the WLAN signal measurements include a signal to noise ratio (SNR) or a noise power measurement.

6. The method of claim 1, wherein the WLAN signal measurements include a time it takes to receive probe responses after a transmission of a probe request is made.

7. The method of claim 1, wherein the WLAN signal measurements include a time interval from a measurement start time to a time a first beacon frame is received for each channel.

8. The method of claim 7, wherein the measurement start time is a time of system startup.

9. The method of claim 1, wherein the WLAN signal measurements include a time it takes to gain access to a medium.

10. The method of claim 1, wherein the WLAN signal measurements include a time interval from a measurement start time to a time an authentication response is received.

11. The method of claim 1, wherein the WLAN signal measurements include a time interval from a measurement start time to a time an association is successfully established.

12. The method of claim 1, wherein the WLAN signal measurements include a number of distinct addresses observed during a selected time interval.

13. The method of claim 1, wherein the WLAN signal measurements include a time interval from a measurement start time to a time a first probe response is received.

14. An apparatus for generating random numbers based on wireless local area network (WLAN) signal measurements, comprising:
a memory; and
a processor coupled to the memory, the processor to:
measure WLAN signals;
harvest entropy based on the WLAN signal measurements; and
generate a random number based on the harvested entropy.

15. The apparatus of claim 14, wherein the WLAN signal measurements include signal strength measurements for beacon signals, frames between client and access points, frames between client devices, or combinations thereof.

16. The apparatus of claim 15, wherein the signal strength is measured in either received signal strength indicator (RSSI) or received channel power indicator (RCPI).

17. The apparatus of claim 14, wherein the WLAN signal measurements include the variation of the received signal strength indicator (RSSI)s or the variation of the received channel power indicator (RCPI)s in a selected measurement interval.

18. The apparatus of claim 14, wherein the WLAN signal measurements include a signal to noise ratio (SNR) or a noise power measurement.

19. The apparatus of claim 14, wherein the WLAN signal measurements include a time it takes to receive probe responses after a transmission of a probe request is made.

20. The apparatus of claim 14, wherein the WLAN signal measurements include a time interval from a measurement start time to a time a first beacon frame is received for each channel.

21. The apparatus of claim 20, wherein the measurement start time is a time of system startup.

22. The apparatus of claim 14, wherein the WLAN signal measurements include a time it takes to gain access to a medium.

23. The apparatus of claim 14, wherein the WLAN signal measurements include a time interval from a measurement start time to a time an authentication response is received.

24. The apparatus of claim 14, wherein the WLAN signal measurements include a time interval from a measurement start time to a time an association is successfully established.

25. The apparatus of claim 14, wherein the WLAN signal measurements include a number of distinct addresses observed during a selected time interval.

26. The apparatus of claim 14, wherein the WLAN signal measurements include a time interval from a measurement start time to a time a first probe response is received.

27. An apparatus for generating random numbers based on wireless local area network (WLAN) signal measurements, comprising:
means for measuring WLAN signals;
means for harvesting entropy based on the WLAN signal measurements; and
means for generating a random number based on the harvested entropy.

28. The apparatus of claim 27, wherein the WLAN signal measurements include signal strength measurements for beacon signals, frames between client and access points, or frames between client devices.

29. A non-transitory computer-readable medium including code which, when executed by a processor, causes the processor to perform a method comprising:
measuring WLAN signals;
harvesting entropy based on the WLAN signal measurements; and
generating a random number based on the harvested entropy.

30. The non-transitory computer-readable medium of claim 29, wherein the WLAN signal measurements include signal strength measurements for beacon signals, frames between client and access points, or frames between client devices.
